(19) United States
(12) Patent Application Publication
(10) Pub. No.: US 2006/0085496 A1
(43) Pub. Date: Apr. 20, 2006

(54) PROGRAMMABLY CONFIGURABLE DIGITAL FILTER

(75) Inventors: Ravi Ananthapur Bacche, San Jose, CA (US); Xu Dong, San Jose, CA (US); Jack Campbell, San Francisco, CA (US)

Correspondence Address: BEYER WEAVER & THOMAS LLP, P.O. BOX 70250, OAKLAND, CA, 94612-0250, US

(73) Assignee: GENESIS MICROCHIP INC., Alviso, CA (US)

(21) Appl. No.: 10/904,863

(22) Filed: Dec. 1, 2004

Related U.S. Application Data
(60) Provisional application No. 60/620,229, filed on Oct. 18, 2004.

(51) Int. Cl. G06F 17/10

(52) U.S. Cl. 708/300

(57) ABSTRACT

A digital filter includes a plurality of connected component digital filters. Control signal generation circuitry is configured to receive a tap output signal from each of at least some of the component digital filters and to process the received tap output signals to generate a control signal to output from the control signal circuitry. Output processing circuitry is configured to process an output of one of the plurality of component digital filters, based on the control signal generated by the control signal circuitry, to generate an output of the digital filter. The processing of the received tap output signals by the control signal generation circuitry may be, for example, programmably configurable.

### CROSS REFERENCE TO RELATED APPLICATIONS

This application claims priority under 35 U.S.C. 119(e) from Provisional U.S. Patent Application Ser. No. 60/620,229, filed Oct. 18, 2004 (Atty. Docket No. GENSP094P), entitled “PROGRAMMABLE WIDE BAND FILTER”, which is incorporated herein by reference in its entirety.

### BACKGROUND OF INVENTION

1. Technical Field

The present invention is in the field of digital filters and, in particular, relates to digital filters that are programmably configurable.

2. Background

A typical method to adjust the response of a digital filter includes changing the filter tap configuration and changing the coefficients of the component digital filters. It is desirable to have the ability to provide greater flexibility while, for example, employing standard digital filter components in a standard configuration.

### SUMMARY OF THE INVENTION

A digital filter includes a plurality of component digital filters connected in a particular configuration. Control signal generation circuitry is configured to receive a tap output signal from each of at least some of the component digital filters and to process the received tap output signals to generate a control signal to output from the control signal circuitry. Output processing circuitry is configured to process an output of one of the plurality of component digital filters, based on the control signal generated by the control signal circuitry, to generate an output of the digital filter. The processing of the received tap output signals by the control signal generation circuitry may be, for example, programmably configurable.

### BRIEF DESCRIPTION OF DRAWINGS

FIG. 1 broadly illustrates a programmable digital filter circuit in accordance with one example, where the component digital filters are connected in a pure serial manner.

FIG. 2 illustrates an example of the control signal generation circuitry of the FIG. 1 circuit.

FIG. 3 illustrates an example programmable digital filter where the control signal generation circuit employs a logical comparison.

FIG. 4 illustrates an example programmable digital filter where the control signal generation circuit employs a divider.

FIG. 5 illustrates a particular example of the FIG. 3 example programmable digital filter circuit.

FIG. 6 illustrates a particular example of the FIG. 4 example programmable digital filter circuit.

FIG. 7 illustrates an example frequency response of the BPF1 digital filter of the FIG. 5 and FIG. 6 circuits.

FIG. 8 illustrates an example frequency response of the BPF2 digital filter of the FIG. 5 and FIG. 6 circuit.

FIG. 9 illustrates the overlap of the FIG. 7 example frequency response of the BPF1 digital filter and the FIG. 8 example frequency response of the BPF2 digital filter.

FIG. 10 illustrates the combined frequency response of the BPF1 digital filter and the BPF2 digital filter, based on the configuration of the control signal generation circuitry using the programmable LIMIT parameter, including both a maximum frequency response (LIMIT=0) and a minimum frequency response (LIMIT=15).

FIG. 11 illustrates another example programmable digital filter circuit where the component digital filters are connected in parallel.

### DETAILED DESCRIPTION

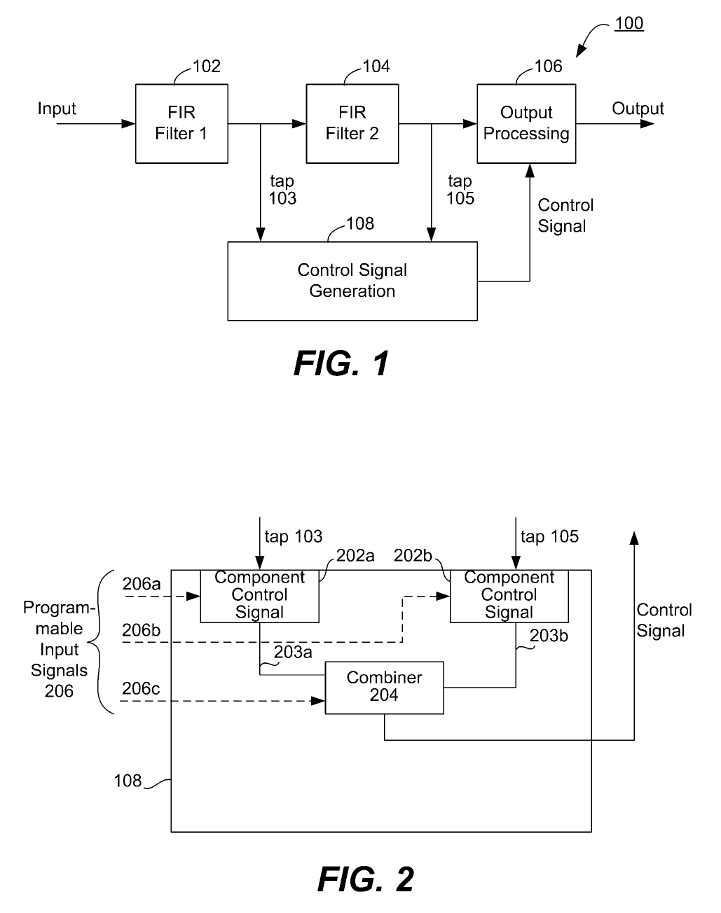

FIG. 1 illustrates an example digital filter 100 in accordance with a broad aspect. The digital filter 100 is a fixed tap based filter with a dynamically operational logical block. In particular, the digital filter 100 includes a first component digital filter 102 and a second component digital filter 104, connected in a particular configuration. In the FIG. 1 example, the component digital filters are connected serially. In some examples, additional digital filters may be connected in the configuration, serially or in parallel, or a combination of both.

Output processing circuitry 106 processes the output of the digital filter 104, based on a control signal, to provide an output of the digital filter 100. The control signal is generated by control signal generation circuitry 108, which is a dynamically operational logic block. The control signal is generated based on a tap output signal 103 provided from the output of digital filter 102 and a tap output signal 105 provided from the output of the digital filter 104.

FIG. 2 broadly illustrates one example of the control signal generation circuitry 108. First component control signal generation circuit 202a generates a component control signal 203a based on the tap output signal 103. Second component control signal generation circuit 202b generates a component control signal 203b based on the tap output signal 105. Combiner circuitry 204 combines the component control signal 203a and the component control signal 203b to generate the control signal to output from the control signal generation circuitry 108. As discussed above relative to FIG. 1, the output processing circuitry 106 processes the output of the digital filter 104 based on the control signal output from the control signal generation circuitry 108.

In some examples, one, some or all of the component control signal generation circuitry 202a, component control signal generation circuitry 202b and the combiner circuitry 204 are programmably configurable. FIG. 2 illustrates programmable input signals 206 provided to the control signal generation circuitry 108. In particular, FIG. 2 illustrates programmable input signal 206a provided to component control signal generation circuitry 202a, programmable input signal 206b provided to component control signal generation circuitry 202b, and programmable input signal 206c provided to combiner circuitry 204. Some examples of the particular programmable configurability are discussed relative to later figures. The programmable input signals 206 may be provided by, for example, a programmable processor such as a microprocessor or other programmable circuitry, such as one or more Application Specific Integrated Circuits.

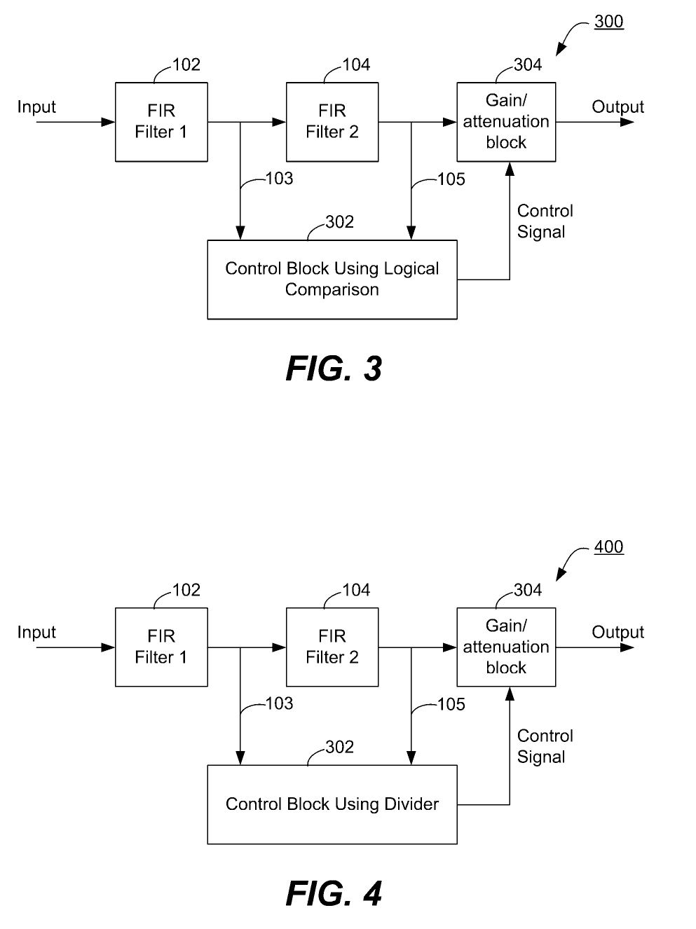

FIG. 3 illustrates a digital filter 300 in which the processing in the control signal generation circuitry 108 (denoted in FIG. 3 by reference numeral 302) may include, for example, logical comparison of signals based on the tap output signal 103 and on the tap output signal 105. The processing by the output processing circuitry 106 (denoted in FIG. 3 by reference numeral 304) may include, for example, gain/attenuation processing.

FIG. 4 illustrates a digital filter 400 in which the processing in the control signal generation circuitry 108 (denoted in FIG. 4 by reference numeral 402) may include, for example, determining a ratio between signals based on the tap output signal 103 and on the tap output signal 105.

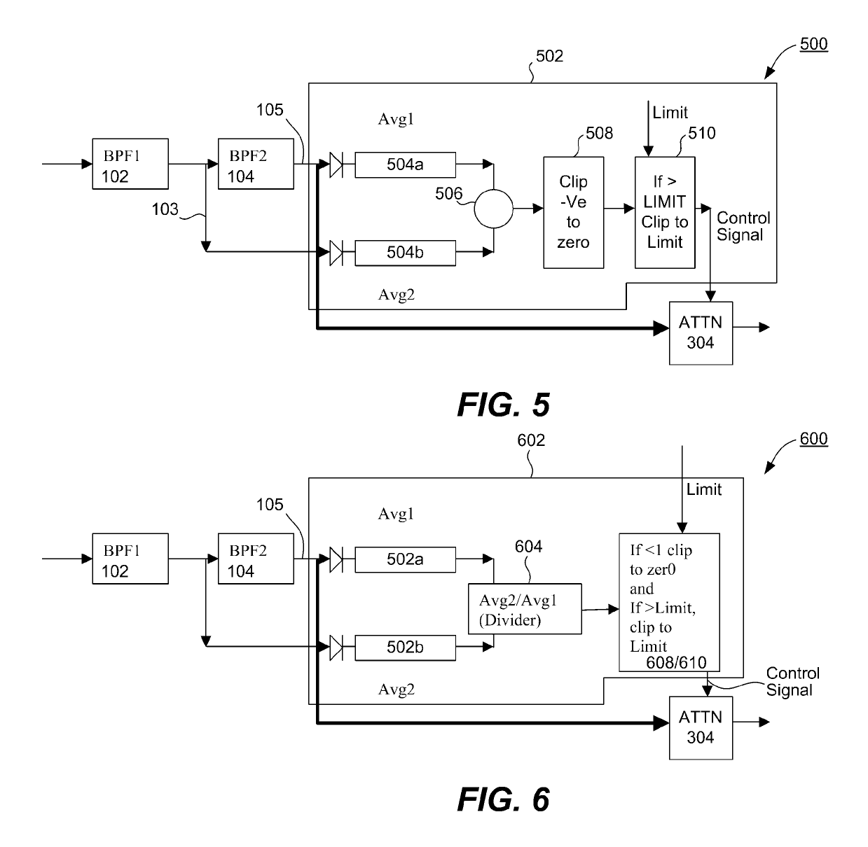

FIG. 5 illustrates a particular example 500 of the FIG. 3 digital filter 300, in which a particular example of the generalized control signal generation circuitry 302 of FIG. 3 is shown as control signal generation circuitry 502. In particular, averaging circuitry 504a and averaging circuitry 504b are coupled to receive the tap output signal 105 and the tap output signal 103, respectively. The output of averaging circuitry 504a is a control signal representing the frequency response of tap output signal 105, and the output of averaging circuitry 504b is a control signal representing the frequency response of tap output signal 103. In one example, the window size of the averaging circuitry 504a and/or the averaging circuitry 504b is programmable to, for example, two, four or eight samples. This programming could be accomplished using the programmable input signal 206b and the programmable input signal 206a, respectively, as shown in FIG. 2.

Since the tap output signal 105 is from the digital filter which receives as input the tap output signal 103, the tap output signal 105 has a combined frequency response of the digital filter 102 and the digital filter 104; and the output of averaging circuitry 504a is a control signal representing the combined frequency response of the digital filter 102 and the digital filter 104.

Differencing circuitry 506 determines a difference between the control signal output from averaging circuitry 504b and from averaging circuitry 504a, and the output of the differencing circuitry 506 is provided to clip circuitry 508. Clip circuitry 508 clips the output of the differencing circuitry 506 to zero as appropriate.

Limiting circuitry 510 receives the output of clip circuitry 508 and limits the output based on a limiting factor LIMIT (which may also be programmable, in a manner similar to the programmable input signal 206a and the programmable input signal 206b). In one example, the limiting circuitry 51 carries out the following operations:
if the output of the clip circuitry 508 is less than LIMIT, then the limiting circuitry 510 divides the output of the clip circuitry 508 by LIMIT and provides the result at the output of the limiting circuitry 510;
and if the output of the clip circuitry 508 is greater than or equal to LIMIT, then the limiting circuitry sets the output of the limiting circuitry 510 to one.

The output of the limiting circuitry 510 is then employed by the gain/attenuating circuitry 304 as a control signal to control gain/attenuation processing. In one example, the output of the gain/attenuation circuitry 304 is the signal at the tap 105 multiplied by a factor of one minus the output of the limiting circuitry 510. For example, the limiting factor LIMIT may be a four-bit value programmable from a minimum of zero (0000b) up to a maximum of 15 (1111b). With the limiting factor LIMIT at 15, the attenuation factor will be a maximum of 0.0625, so if the averaged sample difference is greater than 15, the output of the digital filter 500 will be completely attenuated. By programming the limiting factor LIMIT from 0 to 15, there can be different response curves, changing the roll-off response of the digital filter 500. As a result, the passband response is maintained, while the rolloff/cutoff response is programmable (for example to achieve a sharper response).

FIG. 6 illustrates a particular example 600 of the FIG. 4 digital filter 400, in which a particular example of the generalized control signal generation circuitry 402 of FIG. 4 is shown as control signal generation circuitry 602. The Figure example 600 may be considered similar in most respects to the FIG. 5 example. However, the outputs of the averaging circuitry 504a and 504b are not differenced. Rather, a ratio of the outputs is determined. The clip/limiting circuitry 608/610 clips the result to be between zero and LIMIT (the programmable limiting factor). The resulting control signal is then employed by the gain/attenuating circuitry 304 as a control signal to control gain/attenuation processing.

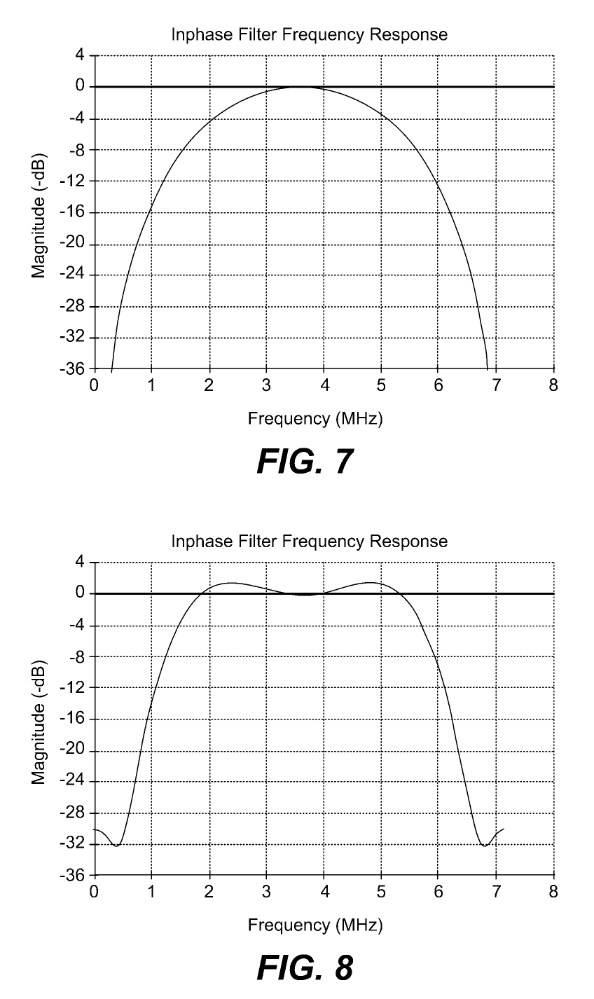

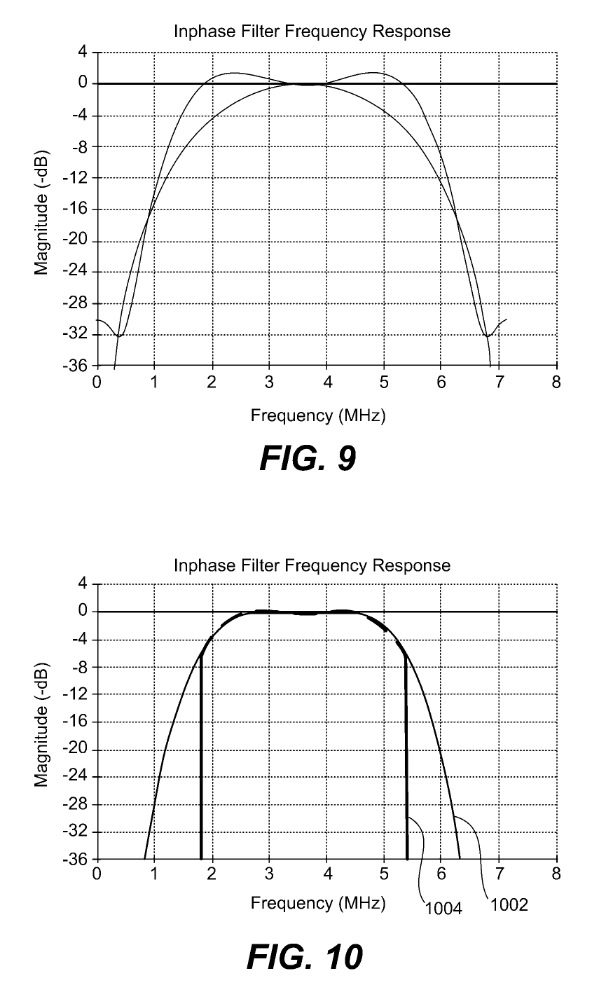

It is instructive to inspect the example frequency response graphs illustrated in FIG. 7, FIG. 8, FIG. 9 and FIG. 10. FIG. 7 illustrates an example frequency response of the of BPF1 102; FIG. 8 illustrates an example frequency response of the BPF2 104; and FIG. 9 illustrates the frequency responses of FIG. 7 and FIG. 8 on a single graph for easier comparison. FIG. 10 illustrates an example output-controlled combined frequency response of, for example, the example 500 (FIG. 5) or the example 600 (FIG. 6). In FIG. 10, the response 1002 represents a maximum bandwidth response of the circuitry (i.e., using the particular examples discussed above, with LIMIT programmed to zero) whereas the response 1004 represents a minimum bandwidth response of the circuitry (i.e., again using the particular examples discussed above, with LIMIT programmed to fifteen).

By making the attenuation factor programmable (i.e., by having the limiting factor LIMIT be programmable), and referring specifically to FIG. 10, different bandwidth responses can be achieved between and including the minimum response 1002 and the minimum response 1004.

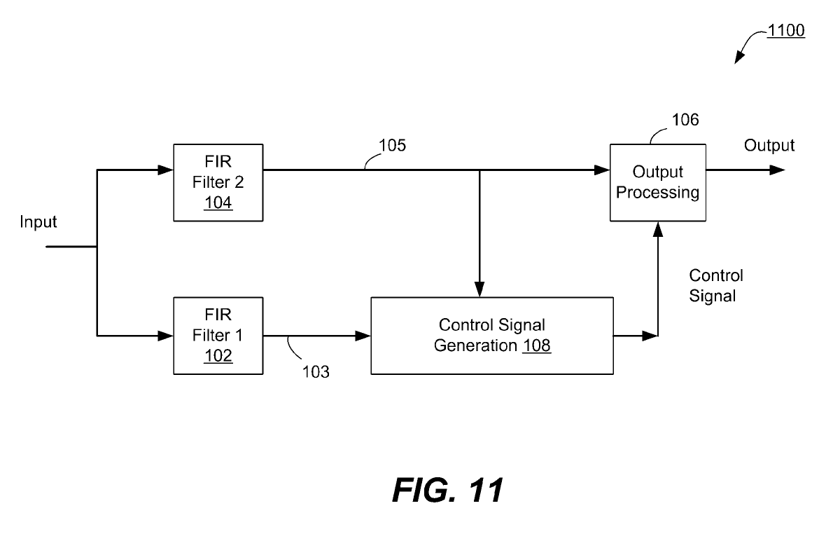

FIG. 11 illustrates an example 1100 where the component digital filters 102 and 104 are connected in parallel. The outputs of the component digital filters are provided to the control signal generation circuitry 108, which controls the output processing by the output processing circuitry 106. In yet other examples, a plurality of component digital filters are connected in a combination of serially and in parallel.

In general, by making the control signal generation circuitry 108 programmable based on tap outputs of the component digital filters, the characteristics of digital filter can be modified without making structural changes such as changing filter coefficients and changing the filter tap output configuration. Minimization of ringing and sharper response can be achieved, and properties of the digital filter 100 can be controlled adaptively for various applications.

What is claimed is:

1. A digital filter, comprising:
a plurality of connected component digital filters;
control signal generation circuitry configured to:
receive a tap output signal from each of at least some of the component digital filters; and
process the received tap output signals to generate a control signal to output from the control signal circuitry; and
output processing circuitry configured to process an output of one of the component digital filters, based on the control signal generated by the control signal circuitry, to generate an output of the digital filter.

2. The digital filter of claim 1, wherein:
processing the received tap output signals by the control signal generation circuitry is programmably configurable.

3. The digital filter of claim 2, wherein:
processing the received tap output signals by the control signal generation circuitry includes a plurality of independently programmably configurable portions.

4. The digital filter of claim 3, wherein:
each of at least some of the independently programmably configurable portions independently process a separate one of the received tap signals.

5. The digital filter of claim 4, wherein:
others of at least some of the independent programmably configurable portions do not independently process a separate one of the received tap signals.

6. The digital filter of claim 4, wherein:
the portions that each independently process a separate one of the received tap signals perform averaging of the separate one of the received tap signals.

7. The digital filter of claim 1, wherein:
the control signal generation circuitry is configured to receive at least one input parameter signal; and
the step of processing the received tap outputs includes processing the received tap outputs based on the at least one input parameter signal.

8. The digital filter of claim 7, further comprising:
circuitry including a programmable processor, configured to determine the at least one input parameter signal and to provide the at least one input parameter signal to the control signal circuitry.

9. The digital filter of claim 1, wherein:
the control signal generation circuitry includes
a plurality of component control signal generation circuitry, each component control signal generation circuitry configured to generate a separate component control signal based on a separate one of the tap outputs; and
control signal combining circuitry configured to process the separate component control signals, to generate the control signal to output from the control signal generation circuitry.

10. The digital filter of claim 9, wherein:
the control signal combining circuitry is configured to process the separate component control signals by at least performing a logical comparison of the separate component control signals.

11. The digital filter of claim 10, wherein:
performing the logical comparison includes performing an arithmetic difference on the separate component control signals.

12. The digital filter of claim 10, wherein the control signal combining circuitry is configured to process the separate component control signals by, further, performing limit processing on a result of the logical comparison of the separate component control signals.

13. The digital filter of claim 12, wherein the performing of limit processing is programmably configurable.

14. The digital filter of claim 11, wherein the control signal combining circuitry is configured to process the separate component control signals by, further, performing limit processing on a result of the arithmetic difference of the separate component control signals.

15. The digital filter of claim 14, wherein the performing of limit processing is programmably configurable.

16. The digital filter of claim 9, wherein:
the control signal combining circuitry is configured to process the separate component control signals by at least performing a ratio of the separate component control signals.

17. The digital filter of claim 14, wherein:
performing the ratio includes performing an arithmetic division on the separate component control signals.

18. The digital filter of claim 16, wherein the control signal combining circuitry is configured to process the separate component control signals by, further, performing limit processing on a result of the ratio of the separate component control signals.

19. The digital filter of claim 18, wherein the performing of limit processing is programmably configurable.

20. The digital filter of claim 17, wherein the control signal combining circuitry is configured to process the separate component control signals by, further, performing limit processing on a result of the arithmetic difference of the separate component control signals.

21. The digital filter of claim 20, wherein the limit processing is programmably configurable.

22. The digital filter of claim 20, further comprising:
circuitry including a programmable processor, configured to programmably configure each component control signal generation circuitry and the control signal combining circuitry.

23. The digital filter of claim 9, wherein:
each component control signal generation circuitry performs an average of the associated separate one of the tap outputs.

24. The digital filter of claim 23, wherein:
each component control signal generation circuitry is independently programmably configurable.

25. The digital filter of claim 24, wherein:
an averaging window of each component control signal generation circuitry is independently programmably configurable.

26. The digital filter of claim 9, wherein:
the control signal combining circuitry performs clip processing on a combination of the separate component control signals.

27. The digital filter of claim 26, wherein:
the clip processing of the control signal combining circuitry is independently programmably configurable.

28. The digital filter of claim 27, wherein:
a clip limit of the clip processing of the control signal combining circuitry is independently programmably configurable.

29. The digital filter of claim 9, wherein:
at least some of the plurality of component control signal generation circuitry are programmably configurable.

30. The digital filter of claim 9, wherein:
the control signal combining circuitry is programmably configurable.

31. The digital filter of claim 1, wherein:
at least some of the plurality of component control signal generation circuitry are programmably configurable; and
the control signal combining circuitry is programmably configurable.

32. The digital filter of claim 1, wherein:
the component digital filters are connected serially.

33. The digital filter of claim 2, wherein:
processing the received tap output signals by the control signal generation circuitry is programmably configurable on a sample by sample basis.

34. The digital filter of claim 1, wherein:
the component digital filters are connected in a combination of serially and in parallel.

35. The digital filter of claim 2, wherein:
processing the received tap output signals by the control signal generation circuitry is programmably configurable on a sample by sample basis of an input signal to the digital filter.

36. A method of configuring a digital filter, wherein
the digital filter includes:
a plurality of connected component digital filters;
control signal generation circuitry configured to:
receive a tap output signal from each of at least some of the component digital filters; and
process the received tap output signals to generate a control signal to output from the control signal circuitry; and
output processing circuitry configured to process an output of one of the component digital filters, based on the control signal generated by the control signal circuitry, to generate an output of the digital filter,
the method comprising:
programmably configuring the processing of the received tap output signals by the control signal generation circuitry to achieve desired output characteristics of the digital filter while refraining from modifying the operation of the component digital filters and from reconfiguring the provision of tap output signals,
whereby the digital filter is adaptable for use in different applications.
